(19) United States
(12) Patent Application Publication
(10) Pub. No.: US 2025/0065797 A1
(43) Pub. Date: Feb. 27, 2025

(54) Three Hole Hook and Catch Device

(71) Applicant: Joseph Alfred Leon, Bakersfield, CA (US)

(72) Inventor: Joseph Alfred Leon, Bakersfield, CA (US)

(21) Appl. No.: 18/454,172

(22) Filed: Aug. 23, 2023

(51) Int. Cl. B60P 7/08

(52) U.S. Cl. CPC B60P 7/0807; B60P 7/0823

(57) ABSTRACT

A novel hook and catch device is disclosed. The device is a one-piece fixed component or a swivel snap hook used as a tie-down hook, with a lanyard, cargo strap, rope, rubber strap, or cord. The hook and catch device comprises a flat body component with three openings and a hook component or a swivel hook component. The hook/swivel hook component is used to secure the device in place on a vehicle. Then, the lanyard, cargo strap, rope, rubber strap, or cord is threaded through the openings and secured, eliminating the need for difficult knots. Further, if used as a cargo hook extension, the hook component of a second device is secured to the top opening of the first device and secured via the lanyard, cargo strap, rope, cord, etc., to the first device.

### FIELD OF THE INVENTION

The present invention relates generally to the field of hook and catch devices. More specifically, the present invention relates to a one-piece fixed component or swivel snap hook used as a tie-down hook or cargo hook extension. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, this invention relates to improvements in hook and catch devices. Generally, people must use difficult knots or re-stitching of cargo lanyards to secure a tie-down hook and/or cargo hook extension. Further, the tie-down hook and/or cargo hook extension are not adjustable.

Additionally, many people transport goods and equipment on a variety of vehicles, often having flatbeds. Without proper securement, such goods and equipment can slide about the vehicle. If the goods or equipment are particularly fragile or delicate, such unsecured movement can result in damage, which can be costly to repair. Typically, to secure containers to the vehicle, tie-down straps are used. However, traditional tie-downs can be difficult to utilize as the tie-downs often do not stay in place. This can result in repeated stops to reapply the tie-downs to ensure that the shipment is not damaged in transit.

Accordingly, a need remains for a hook and catch device that can be adjusted for different lengths. Further, a hook and catch device is necessary to eliminate having to tie difficult knots to retain the tie-down straps in place over cargo.

Therefore, there exists a long-felt need in the art for a hook and catch device that provides users with a one-piece fixed component that can be used as a tie-down hook. There is also a long-felt need in the art for a hook and catch device that provides users with a swivel snap hook which is used as a tie-down hook. Further, there is a long-felt need in the art for a hook and catch device that can be used with a lanyard, cargo strap, rope, rubber strap, or cord. Moreover, there is a long-felt need in the art for a device wherein the swivel snap hook can be used with a dog leash, animal lead, rope, necklace, or bracelet. Further, there is a long-felt need in the art for a hook and catch device that can be used as an extension apparatus of a lanyard rope or strap, when the hook and catch device is used. Finally, there is a long-felt need in the art for a hook and catch device that when used as instructed, becomes a structural member.

The subject matter disclosed and claimed herein, in one embodiment thereof, comprises a hook and catch device. The device is a one-piece fixed component or a swivel snap hook used as a tie-down hook, with a lanyard, cargo strap, rope, rubber strap, or cord. The hook and catch device comprises a flat body component with three openings and a hook component or a swivel hook component. The hook/swivel hook component is used to secure the device in place on a vehicle. Then, the lanyard, cargo strap, rope, rubber strap, or cord is threaded through the openings and secured, eliminating the need for difficult knots. Further, if used as a cargo hook extension, the hook component of a second device is secured to the top opening of the first device and secured via the lanyard, cargo strap, rope, cord, etc., to the first device.

In this manner, the hook and catch device of the present invention accomplishes all of the foregoing objectives and provides users with a device that is adjustable and easy to secure. The device is a one-piece fixed component or a swivel snap hook component. The device can be manufactured of metal, hard plastic, or a combination thereof.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hook and catch device. The device is a one-piece fixed component or a swivel snap hook used as a tie-down hook, with a lanyard, cargo strap, rope, rubber strap, or cord. The hook and catch device comprises a flat body component with three openings and a hook component or a swivel hook component. The hook/swivel hook component is used to secure the device in place on a vehicle. Then, the lanyard, cargo strap, rope, rubber strap, or cord is threaded through the openings and secured, eliminating the need for difficult knots. Further, if used as a cargo hook extension, the hook component of a second device is secured to the top opening of the first device and secured via the lanyard, cargo strap, rope, cord, etc., to the first device.

The hook and catch device has many applications, including securing cargo or objects in or to a vehicle or other structure.

In one embodiment, the hook and catch device comprises a body component having a substantially flat rectangular shape but can be any suitable shape as is known in the art, such as oval, square, etc. Generally, the body component is a one-piece fixed component that comprises a front portion opposite a back portion, opposing side portions, and opposing top and bottom portions. The top portion comprises a hook component configured to secure an attachment point of a vehicle or other object, such as a bracket, cleat, tie-down, hard point, or the like. The hook component can be a rounded or curved hook component, or a squared-off hook component, depending on the needs and/or wants of a user, and/or the size and shape of the bracket, cleat, tie-down, hard point, etc. Further, the hook component can be constructed to accommodate the smallest tie-down, to the largest tie-down for the required applications.

In one embodiment, the hook component comprises a wire hook and a wire body component. In yet another embodiment, the hook component comprises a flattened circle or oval-shaped wire hook and wire body component.

In one embodiment, the top portion comprises a swivel hook component. The swivel hook component would be a swivel snap hook used for pet leashes, animal lead ropes, necklaces, bracelets, etc. The swivel hook component would be a curved hook secured via a pin connection to the top portion, allowing the curved hook to rotate about its axis. The curved hook would also comprise a spring plunger or spring lock to secure the curved hook to the leash, lead rope, necklace, bracelet, etc.

In one embodiment, the body component comprises three openings, a first opening near the top portion, a second opening in the middle, and a third opening near the bottom portion. The three openings can be round, oval, square, rectangular, or octagon in shape or any combination thereof. The three openings do not need to be the same shape, and two of the openings can be a particular shape with the third opening being a different shape, etc. Further, in one embodiment, the third opening is approximately 1.5 times the size of the first and the second openings. The three opening are configured to removably secure a strap, rope, cord, lanyard, etc., therethrough.

In operation, a user secures the hook component or swivel hook component in the desired position on a vehicle or other object. Then, using the desired lanyard, flat webbing rope, rubber straps, cord, cable, etc., the user enters the third opening (i.e., near the bottom portion, farthest away from the hook component). Then, using the same flexible lanyard, enters the second opening (i.e., the middle), then enters the first opening (i.e., the opening closest to the hook component), and finally, enters back into the third opening (i.e., the first opening of entry and the last opening of entry). This secures the flexible lanyard within the device, without the need for difficult knots that need to be tied and untied, during use, and allows the length of the flexible lanyard to be easily adjusted over the cargo, as needed.

In one embodiment, the hook and catch device can be used as a cargo hook extension. When used as an extension, two hook and catch devices are utilized (i.e., a first and a second device), with one device being an extension of the other device. The first hook and catch device is secured to the desired object via the hook component or swivel hook component. Then, a second hook and catch device is secured to the first opening of the first device via its hook component. Thus, the hook component of the second device is secured to the first opening on the first device, and the chosen flexible lanyard is threaded through the three openings to secure the devices in position.

In one embodiment, the body component is a unitary structure having a rigid and durable form, such that the body component resists deformation upon the application of external forces, such as those that occur during securing of cargo within a vehicle bed/roof via tic-downs, etc. The hook and catch device can be utilized to removably secure to a vehicle to ensure a container, pallet, or other such shipment is retained in a desired position during transport.

In one embodiment, the hook and catch device can be manufactured of metals, hard plastics, or a combination thereof. In one embodiment, the body component comprises a covering that comprises a rubberized material for durability and protection. In another embodiment, the body component comprises a covering that comprises a phosphorescent material therein, such that the covering illuminates under low-light conditions. In some such embodiments, the phosphorescent nature of the covering is photo-sensitive such that exposure to light charges the covering for illumination during low-light conditions. In alternate embodiments, the covering further comprises a reflective surface, such that external light sources impacting the covering are reflected towards the external light source. In this manner, the device can be properly visualized in low-light conditions, such as evening roadway travel. In other embodiments, the reflective surface comprises reflective flakes embedded within the material of the covering.

In yet another embodiment, the hook and catch device comprises a plurality of indicia.

In yet another embodiment, a method of securing tie-down straps, rope, cord, or a leash is disclosed. The method includes the steps of providing a hook and catch device comprising a body component with three openings and a hook/swivel hook component. The method also comprises securing the hook or swivel hook component to a desired vehicle or object. Further, the method comprises threading a lanyard, cargo strap, rope, rubber strap, or cord through the three openings to secure the device in position. Finally, the method comprises utilizing a second device as an extension of a first device by securing the second device via the hook component to a top opening of the first device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-E illustrate a multiple-perspective view of one embodiment of the hook and catch device of the present invention showing the swivel hook component of the device in accordance with the disclosed architecture;

FIGS. 2A-E illustrate a multiple-perspective view of one embodiment of the hook and catch device of the present invention showing the hook component of the device in accordance with the disclosed architecture;

FIGS. 3A-D illustrate a multiple-perspective view of one embodiment of the hook and catch device of the present invention showing the wire hook component of the device in accordance with the disclosed architecture;

FIGS. 4A-D illustrate a multiple-perspective view of one embodiment of the hook and catch device of the present invention showing the wire hook component of the device in a flattened embodiment in accordance with the disclosed architecture; and

FIG. 5 illustrates a flowchart showing the method of securing tie-down straps, rope, cord, or a leash in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a hook and catch device that provides users with a one-piece fixed component that can be used as a tie-down hook. There is also a long-felt need in the art for a hook and catch device that provides users with a swivel snap hook which is used as a tie-down hook. Further, there is a long-felt need in the art for a hook and catch device that can be used with a lanyard, cargo strap, rope, rubber strap, or cord. Moreover, there is a long-felt need in the art for a device wherein the swivel snap hook can be used with a dog leash, animal lead, rope, necklace, or bracelet. Further, there is a long-felt need in the art for a hook and catch device that can be used as an extension apparatus of a lanyard rope or strap, when the hook and catch device is used. Finally, there is a long-felt need in the art for a hook and catch device that when used as instructed, becomes a structural member.

The present invention, in one exemplary embodiment, is a novel hook and catch device. The device is a one-piece fixed component or a swivel snap hook used as a tie-down hook, with a lanyard, cargo strap, rope, rubber strap, or cord. The hook and catch device comprises a flat body component with three openings and a hook component or a swivel hook component. The hook/swivel hook component is used to secure the device in place on a vehicle. Then, the lanyard, cargo strap, rope, rubber strap, or cord is threaded through the openings and secured, eliminating the need for difficult knots. Further, if used as a cargo hook extension, the hook component of a second device is secured to the top opening of the first device and secured via the lanyard, cargo strap, rope, cord, etc., to the first device. The present invention also includes a novel method of securing tie-down straps, ropes, cords, or a leash. The method includes the steps of providing a hook and catch device comprising a body component with three openings and a hook/swivel hook component. The method also comprises securing the hook or swivel hook component to a desired vehicle or object. Further, the method comprises threading a lanyard, cargo strap, rope, rubber strap, or cord through the three openings to secure the device in position. Finally, the method comprises utilizing a second device as an extension of a first device by securing the second device via the hook component to a top opening of the first device.

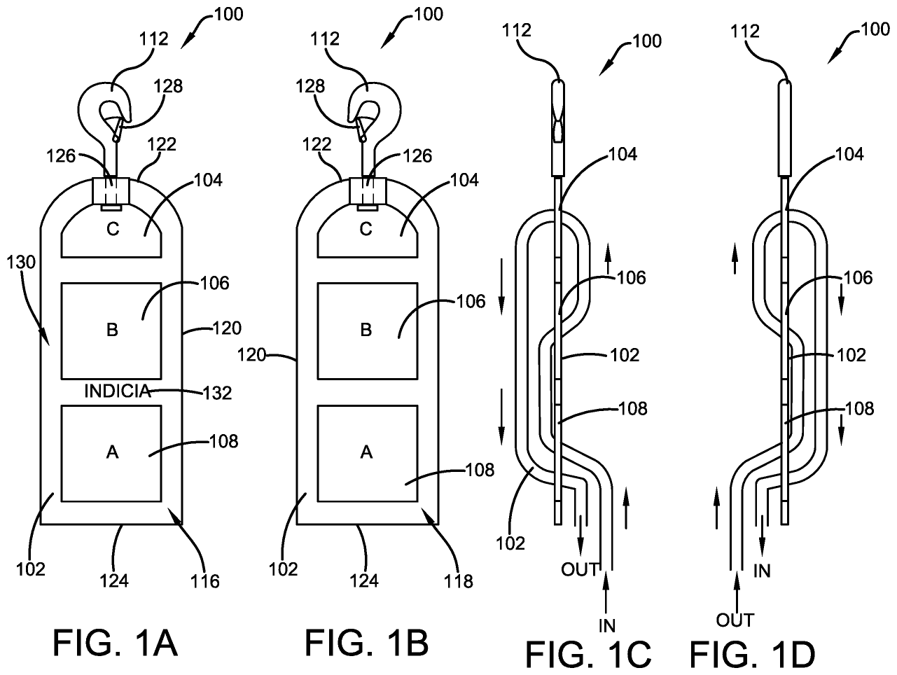

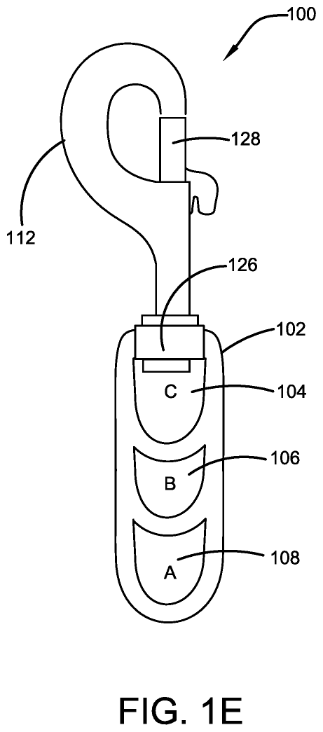

Referring initially to the drawings, FIGS. 1A-E illustrates a perspective view of one embodiment of the hook and catch device 100 of the present invention. In the present embodiment, the hook and catch device 100 is an improved hook and catch device 100 that can be used as a tic-down hook or cargo hook extension. The device 100 is a one-piece fixed component or a swivel snap hook used as a tie-down hook, with a lanyard 114, cargo strap, rope, rubber strap, or cord. Specifically, the hook and catch device 100 comprises a body component 102 with three openings 104, 106, 108, and a hook component 110 or swivel hook component 112. The hook 110/swivel hook 112 component is used to secure the device 100 in place on a vehicle. Then, the lanyard 114, cargo strap, rope, rubber strap, or cord is threaded through the openings 104, 106, 108, and secured, eliminating the need for difficult knots.

The hook and catch device 100 has many applications, including securing cargo or objects in or to a vehicle or other structure. Further, when the hook and catch device 100 comprises a swivel hook 112, the device 100 can be used with a dog leash, animal lead rope, necklace, bracelet, etc.

Generally, the hook and catch device 100 comprises a body component 102 having a substantially flat rectangular shape but can be any suitable shape as is known in the art, such as oval, square, etc. Further, the body component 102 is a one-piece fixed component that comprises a front portion 116 opposite a back portion 118, opposing side portions 120, and opposing top 122 and bottom 124 portions. The body component 102 can be any suitable shape and size as is known in the art, depending on the needs and/or wants of a user and the application intended.

Furthermore, the top portion 122 of the body component 102 comprises a swivel hook component 112. The swivel hook component 112 would be a swivel snap hook used for pet leashes, animal lead ropes, necklaces, bracelets, etc. The swivel hook component 112 would be a curved hook secured via a pin connection 126 to the top portion 122, allowing the curved hook to rotate about its axis. The curved hook would also comprise a spring plunger or spring lock 128 to secure the curved hook to the leash, lead rope, necklace, bracelet, etc.

Additionally, the body component 102 comprises three openings, a first opening 104 near the top portion 122, a second opening 106 in the middle, and a third opening 108 near the bottom portion 124. The three openings 104, 106, 108, can be round, oval, square, rectangular, or octagon in shape, or any combination thereof. The three openings 104, 106, 108, do not need to be the same shape, and two of the openings can be a particular shape with the third opening being a different shape, etc. Further, in one embodiment, the third opening 108 is approximately 1.5 times the size of the first 104 and the second 106 openings. The three openings 104, 106, 108, are configured to removably secure a strap, rope, cord, lanyard 114, etc., therethrough.

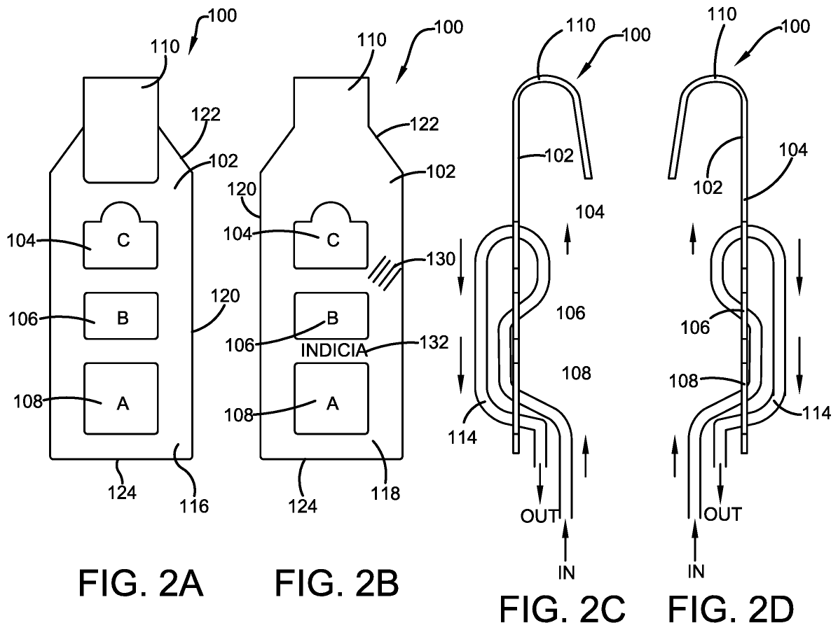

As shown in FIGS. 2A-E, the top portion 122 comprises a hook component 110 configured to secure about an attachment point of a vehicle or other object, such as a bracket, cleat, tie-down, hard point, or the like. The hook component 110 can be a rounded or curved hook component, or a squared-off hook component, depending on the needs and/or wants of a user, and/or the size and shape of the bracket, cleat, tie-down, hard point, etc. Further, the hook component 110 can be constructed to accommodate the smallest tie-down, to the largest tie-down for the required applications, and can be any suitable size and shape as is known in the art.

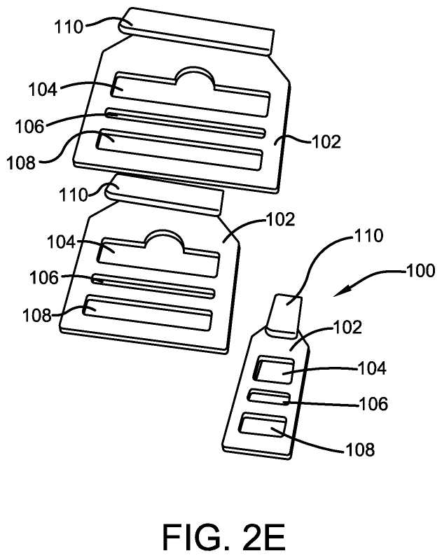

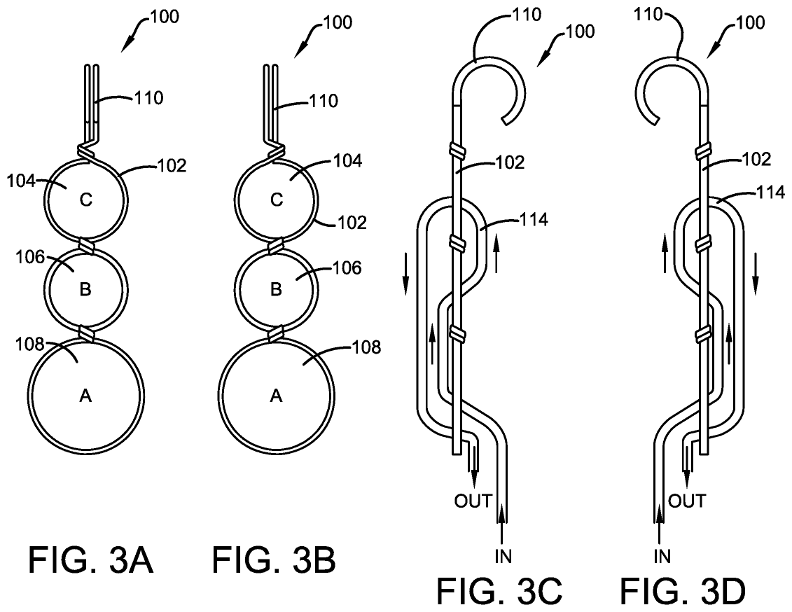

As shown in FIGS. 3A-D and 4A-D, the hook component 110 comprises a wire hook and wire body component 102. In yet another embodiment, the hook component 110 comprises a flattened circle or oval-shaped wire hook component 110 and wire body component 102. As stated supra, the hook component 110 and/or body component 102 can be any suitable shape and size as is known in the art, depending on the user's wants and/or needs and the intended application.

In operation, a user secures the hook component 110 or swivel hook component 112 in the desired position on a vehicle or other object. Then, using the desired lanyard 114, flat webbing rope, rubber straps, cord, or cable, etc., the user enters the third opening 108 (i.e., near the bottom portion 124, farthest away from the hook component 110). Then, using the same flexible lanyard 114 enters the second opening 106 (i.e., the middle), then enters the first opening 104 (i.e., the opening closest to the hook component 110), and finally, enters back into the third opening 108 (i.e., the first opening of entry and the last opening of entry). This secures the flexible lanyard 114 within the device 100, without the need for difficult knots that need to be tied and untied, during use, and allows the length of the flexible lanyard 114 to be easily adjusted over the cargo, as needed.

Further, in one embodiment, the hook and catch device 100 can be used as a cargo hook extension when additional length may be needed. When used as an extension, two hook and catch devices 100 are utilized (i.e., a first 101 and a second 103 device), with one device being an extension of the other device. The first hook and catch device 101 is secured to the desired object via the hook component 110 or swivel hook component 112. Then, a second hook and catch device 103 is secured to the first opening 104 of the first device 101 via its hook component 110. Thus, the hook component 110 of the second device 103 is secured to the first opening 104 on the first device 101, and the chosen flexible lanyard 114 is threaded through the three openings 104, 106, 108 to secure the devices 101 and 103 in position.

In one embodiment, the body component 102 is a unitary structure having a rigid and durable form, such that the body component 102 resists deformation upon the application of external forces, such as those that occur during securing of cargo within a vehicle bed/roof via tie-downs, etc. The hook and catch device 100 can be utilized to removably secure to a vehicle to ensure a container, pallet, or other such shipment is retained in a desired position during transport.

Generally, the hook and catch device 100 can be manufactured of metals, hard plastics, or a combination thereof. In one embodiment, the body component 102 comprises a covering 130 that comprises a rubberized material for durability and protection. In another embodiment, the body component 102 comprises a covering 130 that comprises a phosphorescent material therein, such that the covering illuminates under low-light conditions. In some such embodiments, the phosphorescent nature of the covering 130 is photo-sensitive such that exposure to light charges the covering 130 for illumination during low-light conditions. In alternate embodiments, the covering 130 further comprises a reflective surface, such that external light sources impacting the covering 130 are reflected towards the external light source. In this manner, the device 100 can be properly visualized in low-light conditions, such as evening roadway travel. In other embodiments, the reflective surface comprises reflective flakes embedded within the material of the covering 130.

In yet another embodiment, the hook and catch device 100 comprises a plurality of indicia 132. The body component 102 of the device 100 may include advertising, a trademark, or other letters, designs, or characters, printed, painted, stamped, or integrated into the body component 102, or any other indicia 132 as is known in the art. Specifically, any suitable indicia 132 as is known in the art can be included, such as, but not limited to, patterns, logos, emblems, images, symbols, designs, letters, words, characters, animals, advertisements, brands, etc., that may or may not be tic-down, cargo, or brand related.

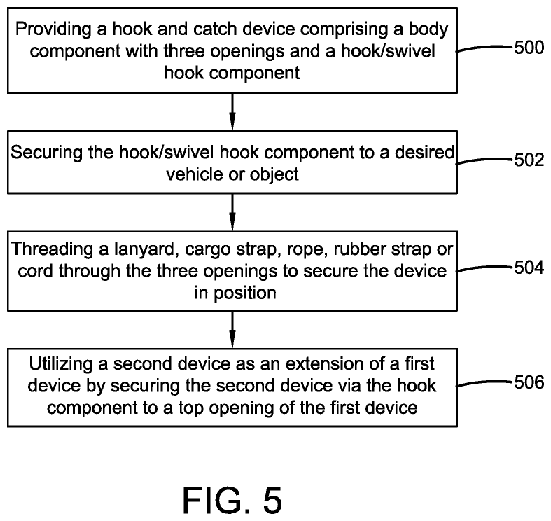

FIG. 5 illustrates a flowchart of the method of securing tie-down straps, rope, cord, or leash. The method includes the steps of at 500, providing a hook and catch device comprising a body component with three openings and a hook/swivel hook component. The method also comprises at 502, securing the hook or swivel hook component to a desired vehicle or object. Further, the method comprises at 504, threading a lanyard, cargo strap, rope, rubber strap, or cord through the three openings to secure the device in position. Finally, the method comprises at 506, utilizing a second device as an extension of a first device by securing the second device via the hook component to a top opening of the first device.

Certain terms are used throughout the following description and claims to refer to particular features or components. As one skilled in the art will appreciate, different users, may refer to the same feature or component by different names. This document does not intend to distinguish between components or features that differ in name but not structure or function. As used herein “hook and catch device” and “device” are interchangeable and refer to the hook and catch device 100 of the present invention.

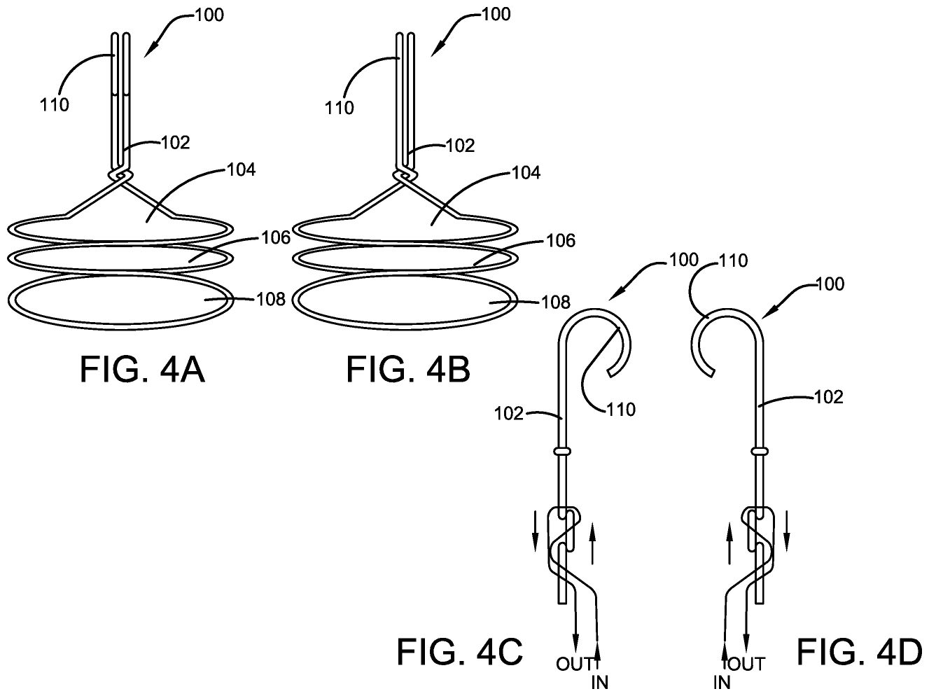

Notwithstanding the foregoing, the hook and catch device 100 of the present invention can be of any suitable size and configuration as is known in the art without affecting the overall concept of the invention, provided that it accomplishes the above-stated objectives. One of ordinary skill in the art will appreciate the hook and catch device 100 as shown in FIGS. 1-5 is for illustrative purposes only, and many other sizes and shapes of the hook and catch device 100 are well within the scope of the present disclosure. Although the dimensions of the hook and catch device 100 are important design parameters for user convenience, the hook and catch device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hook and catch device that is used as a tie-down hook, the hook and catch device comprising:
a body component; and
a hook component; and
wherein the hook component is secured to a top portion of the body component;
wherein the hook component is utilized to secure the hook and catch device in position on a vehicle; and
further wherein the body component comprises a plurality of openings to thread a strap through to secure the hook and catch device in position over cargo.

2. The hook and catch device of claim 1, wherein the body component and the hook component are a one-piece fixed component used as a tie-down hook.

3. The hook and catch device of claim 2, wherein the strap is a lanyard, a cargo strap, a rope, a rubber strap, or a cord.

4. The hook and catch device of claim 3, wherein the body component has a substantially flat rectangular shape and comprises a front portion opposite a back portion, opposing side portions, and opposing top and bottom portions.

5. The hook and catch device of claim 4, wherein the hook component is a rounded hook and is configured to secure about an attachment point of a vehicle.

6. The hook and catch device of claim 4, wherein the hook component is a wire hook and the body component is a wire body component.

7. The hook and catch device of claim 4, wherein the top portion of the body component comprises a swivel hook component.

8. The hook and catch device of claim 7, wherein the swivel hook component is a curved hook with a spring lock, which is secured via a pin connection to the top portion, allowing the curved hook to rotate about its axis.

9. The hook and catch device of claim 4, wherein the plurality of openings comprise three openings, a first opening near the top portion, a second opening in the middle, and a third opening near the bottom portion.

10. The hook and catch device of claim 9, wherein the third opening is approximately 1.5 times size of the first and the second openings.

11. The hook and catch device of claim 10, wherein the hook and catch device is used as a cargo hook extension by securing two hook and catch device together.

12. The hook and catch device of claim 11, wherein the body component comprises a covering that comprises a rubberized material for durability and protection and a phosphorescent material for illuminating under low-light conditions.

13. A hook and catch device that is used as a tie-down hook, the hook and catch device comprising:
a body component with a substantially flat rectangular shape and comprising a front portion opposite a back portion, opposing side portions, and opposing top and bottom portions; and
a hook component; and
wherein the hook component is secured to the top portion of the body component;
wherein the hook component is utilized to secure the hook and catch device in position on a vehicle; and
wherein the body component comprises a first opening near the top portion, a second opening in the middle, and a third opening near the bottom portion to thread a strap through to secure the hook and catch device in position over cargo; and
further wherein in operation, a user utilizes a flexible lanyard to enter the third opening, then enters the second opening with the flexible lanyard, then enters the first opening, and finally, enters back into the third opening to secure the flexible lanyard within the body component.

14. The hook and catch device of claim 13 further comprising a plurality of indicia.

15. The hook and catch device of claim 13, wherein the hook component is a rounded hook and is configured to secure about an attachment point of a vehicle.

16. The hook and catch device of claim 13, wherein the hook component is a wire hook and the body component is a wire body component.

17. The hook and catch device of claim 13, wherein the top portion of the body component comprises a swivel hook component.

18. The hook and catch device of claim 17, wherein the swivel hook component is a curved hook with a spring lock, which is secured via a pin connection to the top portion, allowing the curved hook to rotate about its axis.

19. The hook and catch device of claim 13, wherein the hook and catch device is used as a cargo hook extension by securing two hook and catch device together.

20. A method of securing tie-down straps, rope, cord, or a leash, the method comprising the following steps:
providing a hook and catch device comprising a body component with three openings and a hook/swivel hook component;
securing the hook or swivel hook component to a desired vehicle or object;
threading a lanyard, cargo strap, rope, rubber strap, or cord through the three openings to secure the device in position; and
utilizing a second device as an extension of a first device by securing the second device via the hook component to a top opening of the first device.
